(19) United States
(12) Patent Application Publication
(10) Pub. No.: US 2004/0238484 A1
(43) Pub. Date: Dec. 2, 2004

(54) Method of manufacturing a microfluidic structure, in particular a biochip, and structure obtained by said method

(76) Inventors: Bruno Le Pioufle, Paris (FR); Horoyuki Fujita, Tokyo (JP); Eiichi Tamiya, Ishikawa (JP); Laurent Griscom, Rennes (FR); Patrick Degenaar, Amsterdam (NL)

Correspondence Address: MORGAN LEWIS & BOCKIUS LLP, 1111 PENNSYLVANIA AVENUE NW, WASHINGTON, DC, 20004, US

(21) Appl. No.: 10/480,082

(22) PCT Filed: Jun. 8, 2001
(86) PCT No.: PCT/EP01/07058

(51) Int. Cl. H05H 1/26; B29C 33/40; B29C 59/16

(52) U.S. Cl. 216/27; 264/219; 264/446; 264/483

(57) ABSTRACT

A method of manufacturing a microfluidic structure, in particular a biochip, said method consisting at least:

in manufacturing a three-dimensional micro-mould with means for defining a three-dimensional geometry including at least micro-wells and micro-grooves or micro-channels interconnecting said micro-wells; and

in using only said three-dimensional micro-mould for molding a membrane made of a polymer material, said membrane incorporating at least said micro-wells and said micro-grooves or micro-channels, said membrane constituting a three-dimensional microfluidic structure.

The present invention relates to a method of manufacturing a microfluidic structure, in particular a biochip, and to a structure obtained by said method.

There is increasing interest in the biological and medical research community to integrate micromachined structures and microelectronics for biological measurements or micromanipulation. Microstructures for rapid separation and isolation of cells in biological assays are of great interest for research laboratories and pharmaceutical industry. For instance, in the case of neural cultures, controlled guidance of neurons is a desired feature of a biochip for the research and understanding of complex developing neural networks.

The new field of microfluidics is turning out to be a boon for the biotech industry in providing inexpensive, biologically compatible and disposible tools for handling small quantities of biological materials and chemicals. Microfluidic structures have become essential in techniques such as PCR and capillary electrophoretic cell manipulation. These microfluidic tools are often made using a variant of poly-dimethylsiloxane (PDMS) in which the channels are typically made through micromoulding and placement on a glass substrate. These structures, however, are often closed structures limited to two dimensions with an input and an output end. Some more complex multi level structures can be made through stacking multiple layers of microfluidics, but these are often difficult to align and are do not offer truly micro scale alignment.

An object of the invention is to conceive a new microfluidic structure, in particular a biochip, said microfluidic structure having a three-dimensional geometry.

To this end, the invention provides a method of manufacturing a microfluidic structure, in particular a biochip, said method consisting at least:

in manufacturing a three-dimensional micro-mould with means for defining a three-dimensional geometry including at least micro-wells and micro-grooves or micro-channels interconnecting said micro-wells; and

in using only said three-dimensional micro-mould for molding a membrane made of a polymer material, said membrane incorporating at least said micro-wells and said micro-grooves or micro-channels, said membrane constituting a three-dimensional microfluidic structure.

In another implementation, the method consists in completing the three-dimensional microfluidic structure by a substrate, one face of the substrate being applied on one face of the membrane.

In particular, the method consists:

in manufacturing said three dimensional micro-mould with means for defining a three-dimensional geometry including at least means for defining micro-wells and micro-grooves,

in using only said three-dimensional micro-mould for molding a membrane made of polymer material, where the micro-wells are crossing the membrane, and the micro-grooves are located on one of the membrane faces and interconnecting said micro-wells, and

in setting into contact said one face of the membrane and one face of the substrate in order to close one free end of the micro-wells, and to close the micro-grooves to form embedded channels interconnecting said micro-wells.

By way of example, the method consists in injecting the polymer material between the micro-mould and a plate pressed onto the top of the micro-mould, and in baking the polymer material at a temperature of about 70° C. during approximatively one hour, in order to form said membrane with said micro-wells crossing the membrane and said micro-grooves located on one of the membrane faces.

Advantageously, the method consists in using a polymer material having hydrophobic properties to form the membrane, and in using a substrate made of a material having also hydrophobic properties, in order to obtain a natural adherence between the membrane and the substrate.

By way of example, the method consists in using a polymer material such as a polydimethylsiloxane (PDMS) to form the membrane.

Advantageously, the method consists in rendering hydrophilic the micro-wells and the micro-grooves or the micro-channels of the membrane by a treatment such as an oxygen plasma treatment.

In particular, the method consists in setting in contact said membrane with a glass substrate before applying the oxygen plasma treatment, the face of the membrane in contact with the glass substrate keeping its hydrophobic properties.

In a first implementation, the method consists in obtaining a silicon micro-mould by an Inductive Coupled Plasma Reactive Ion Etching (ICP RIE), said etching being tri-dimensional and requiring at least a first etching to form the micro-grooves or micro-channels and a second etching to form the micro-wells.

Advantageously, in said first implementation, the method consists in exposing the obtained silicon micro-mould to a CHF3 plasma treatment in order to minimize the adherence between the surface of the obtained silicon micro-mould and the membrane to be molded in said silicon micro-mould.

In a second implementation, the method consists in obtaining a resist micro-mould by at least two successive UV exposures through a mask and without intermediate developing, the first exposure defining means for forming the micro-grooves and the second exposure, after spin-coating a second resist layer, defining means for forming the micro-wells.

Advantageously, in said second implementation, said method consists in using a resist such as a SU8.

The invention relates also to a three-dimensional microfluidic structure as obtained by the method according to the invention.

Combination of micromachined biochips to three-dimentional structured microfluidic membranes will lead to highly parallelised bio-microsystems, capable to isolate single cells, or small groups of living cells, in an array of minimum several hundreds of wells, for sensing or manipulation purposes. These so called cell-biochips have great interest for industry or for the research.

In particular, the invention is useful where a great number of parallel manipulations have to be held on living cells. The proposed three-dimensional microfluidic structure, arranging cells in an array of micro-wells, underground-connected by means of microfluidic channels may have applications for:

Pharmacology and high output screening where highly parallelized techniques are absolutely necessary; in the three-dimensional microfluidic structure, the open wells containing single cells are connected to underground microfluidic network which permits the addressing of pharmaceutics products (very few products, fast, highly paralelized),

Gene transfer, as nowadays transfection techniques are not efficient, and the cell-chip of the invention could be a key device, being capable to isolate single cells as an array for analysis and optimization of the transfection,

ex-vivo culture and guided growth of neurons, for fundamental research, and

cell bio-sensors (measurement of environment effects and pollution effects on cells).

Other characteristics, advantages, and details of the invention appear from the following explanatory description with reference to the accompanying drawings, given purely by way of example, and in which:

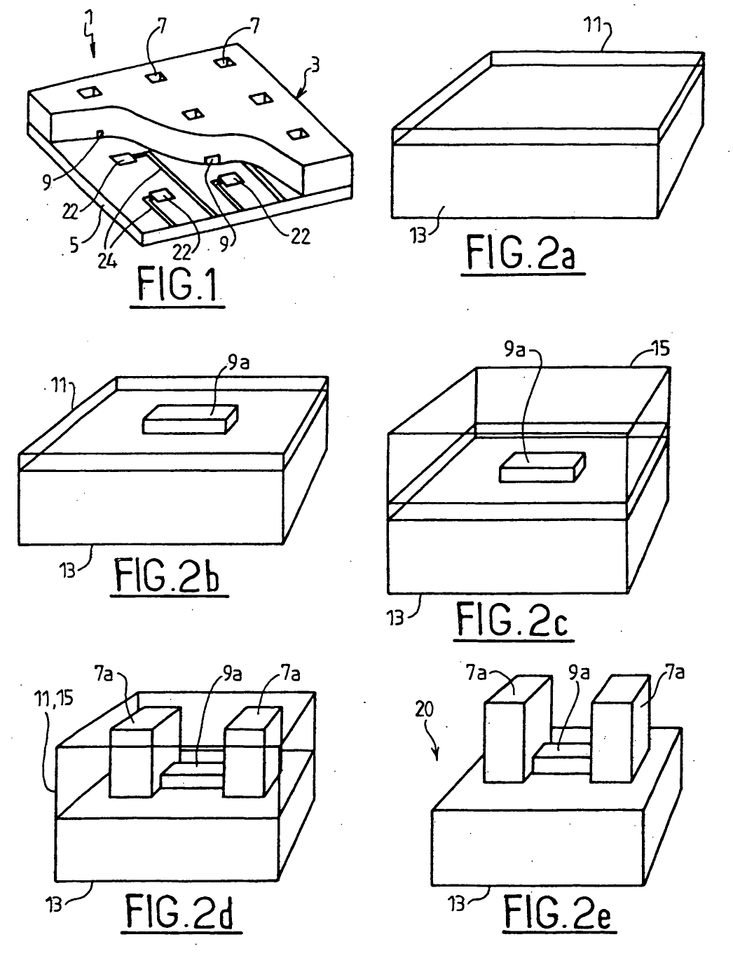

FIG. 1 is fragmentary perspective view of a three-dimensional microfluidic structure manufactured according to the method of the invention, and

FIG. 2a to 2e are schematic views for illustrating the method of the invention according to a preferred implementation.

A three-dimensional microfluidic structure 1 according to one embodiment of the invention is illustrated on FIG. 1.

The three-dimensional microfluidic structure 1 is formed by at least a membrane 3 and a substrate 5. The membrane 3 incorporates at least an array of vertical micro-wells 7 crossing said membrane 3, and longitudinal micro-grooves 9 located on one of the membrane faces and interconnecting at least some of said micro-wells 7.

This three-dimensional microfluidic structure 1 is directly obtained by molding according to a first or second technique.

The first technique permits to obtain a silicon micro-mould, by means of deep plasma etching (ICP RIE Inductive Coupled Plasma Reactive Ion Etching). The etching has to be tri-dimensional, and at least two-levels etching are required: one for the micro-channels and one for the open wells.

Advantageously, the surface of the three-dimensional microfluidic structure is covered by a carbonic polymer, obtained by means of exposing the surface to a CHF3 plasma, in order to minimize the adherence between the surface of the obtained micro-mould and the micro-membrane to be molded.

The second technique permits to obtain a thick resist mould, the resist used being SU8 for example. In general, at least two successive UV exposures are required through a mask, without any intermediate developing, permit to define the three-dimensional geometry of the membrane. Concretely, at least a first exposure permits to define the geometry of the micro-channels, and a second exposure, after spin-coating a second resist layer, permits to define the geometry of the micro-wells. The alignment between the two geometries can be made without developing the resist of successive layers: indeed the UV exposure changes the refraction index of exposed resist, the exposed surfaces becoming thus visible. A more complex structure could be obtained by spin-coating and UV exposing of successive layers. The total geometry of the micro-mould is then developed in a specific developer.

In particular, the method consists in a first step as illustrated on FIG. 2a, to spin-coat a first layer 11 of SU8 on a face of a substrate 13. The thickness of this first layer 11 is of about 20 μm to 300 μm, this thickness being defined by the speed and the duration of the spin-coating operation. The first layer 11 is then baked.

In a second step as illustrated on FIG. 2b, the first resist layer 11 is submitted to a UV exposure through a mask (not represented) to define at least the geometry 9a of the micro-grooves 9.

In a third step as illustrated on FIG. 2c, without developing the first layer 11, a second resist layer 15 is spin-coated on the first layer 11. The thickness of the second layer 15 is also defined by the speed and the duration of this spin-coating operation, the thickness being of about 20 μm to 300 μm. The second layer 15 is then baked.

In a fourth step as illustrated on FIG. 2d, the second resist layer 15 is submitted to a UV exposure through a mask (non represented) for defining at least the geometry 7a of the micro-wells 7.

In a final step as illustrated on FIG. 2e, the structure is developed in a manner known per se to obtain a three-dimensional micro-mould 20 including means for defining longitudinal micro-grooves 9 and vertical micro-wells 7. The alignment between the layers 11 and 15 is performed owing to the change of the refractive index of the exposed surfaces which become visible by microscopy.

The three-dimensional micro-mould 20, obtained by one of the two methods presented, is then used to mould a membrane made of a polymer material, such as a polydimethylsiloxane (PDMS) having hydrophobic properties. The polymer (PDMS) is injected between the mould and a polyacrylic plate, pressed onto the top of the mould structure. After one hour of 70° C. baking, the membrane is formed: micro-wells are crossing the membrane, and micro-channels are formed on one of the membrane faces.

In a first embodiment, the micro-molded membrane can constitute a three-dimensional microfluidic structure.

In a second embodiment, as illustrated on FIG. 1, the micro-molded membrane 3 is associated with the substrate 5.

By way of example, the substrate 5 can be constituted by an electronic chip comprising at least micro-electrodes 22 which are connected to an electronic circuitry through micro-conductors 24. The micro-electrodes 22 can be golded and, advantageously, the substrate 5 is made of a material having hydrophobic properties.

The membrane is directly placed onto the electronic chip, under a microscope, so that micro-wells can be aligned onto the electrodes of the electronic-chip. The membrane and the electronic-chip adhere together due to their hydrophobic properties.

Advantageously, the micro-conductors 24 and the substrate 5 are transparent, in order to be able to visualize the microfluidic structure through microscopy. For instance, the substrate 5 is formed by a glass plate, and the micro-conductors 24 are in ITO.

In general, the materials are chosen in order to ensure the biocompatibility of the microfluidic structure with biological substances and living cells to be treated by the microfluidic structure. If the materials used do not satisfy the condition of biocompatibility, said materials are treated accordingly, i.e. with an appropriate coating.

Micro-wells and micro-channels have to be rendered hydrophilic, in order to permit to cells to enter into the micro-wells, and to permit to aqueous bio-chemical compounds to enter into the micro-channels. In the other hand, the micro-membrane surface facing the electronic chip has to keep its hydrophobic properties in order to keep adherence between both surfaces. For example, an oxygen plasma treatment is applied to the membrane while maintaining this one stuck onto a glass substrate (different to the electronic chip substrate): the plasma penetrates and modifies the properties of micro-wells and micro-channels, rendering their surfaces hydrophilic.

In general, in a three-dimensional microfluidic structure obtained by the method according to the invention, the micro-wells of the membrane have dimensions varying from 30 μm to 100 μm, the membrane has a thickness of about 40 μm to 300 μm. Furthermore, the micro-channels have a rectangular section with sizes vary from 10 μm to 300 μm, and the number of micro-wells can be comprised in a range of 100 to 10000/cm².

1.-21. (canceled)

22. A method of manufacturing a microfluidic structure, said method consisting essentially of:
manufacturing a three-dimensional micro-mould with means for defining a three-dimensional geometry including at least micro-wells and micro-grooves or micro-channels interconnecting said micro-wells; and
directly molding a membrane made of a polymer material in the three-dimensional micro-mould, said membrane incorporating at least said micro-wells crossing said membrane and said micro-grooves or micro-channels interconnecting at least some micro-wells on one of the membrane faces, said membrane constituting a three-dimensional microfluidic structure with a number of micro-wells ranging from 100 to 10,000/cm².

23. A method according to claim 22, further comprising completing the three-dimensional microfluidic structure by adding a substrate, one face of which is applied on one face of the membrane.

24. A method according to claim 23, consisting essentially of:
manufacturing said three-dimensional micro-mould with means for defining a three-dimensional geometry, including at least means for defining micro-wells and micro-grooves,
molding a membrane made of polymer material in the three-dimensional micro-mould, wherein the micro-wells are crossing the membrane, and the micro-grooves are located on one of the membrane faces and interconnecting said micro-wells, and
contacting said one face of the membrane with one face of the substrate, in order to close one free end of the micro-wells, and to close the micro-grooves to form embedded channels interconnecting said micro-wells.

25. A method according to claim 22, wherein said molding comprises
injecting the polymer material between the micro-mould and a plate pressed on to the top of the micro-mould, and
baking the polymer material at a temperature of about 70° C. for approximately one hour, in order to form said membrane with said micro-wells crossing the membrane and said micro-grooves on one of the membrane faces.

26. A method according to claim 23, wherein the polymer material exhibits hydrophobic properties sufficient to form the membrane, and the substrate consists essentially of a material that exhibits sufficient hydrophobic properties such that a natural adherence between the membrane and the substrate occurs.

27. A method according to claim 26, wherein the polymer material is polydimethylsiloxane (PDMS).

28. A method according to claim 22, further comprising rendering the micro-wells and the micro-grooves or the micro-channels of the membrane hydrophilic by oxygen plasma treatment.

29. A method according to claim 28, said rendering comprises contacting said membrane with a glass substrate before applying the oxygen plasma treatment, wherein the face of the membrane in contact with the glass substrate maintains its hydrophobic properties.

30. A method according to claim 22, wherein said mould is a silicon micro-mould obtained by an Inductive Coupled Plasma Reactive Ion Etching (ICP RIE), in which said etching is tri-dimensional and requires at least a first etching to form the micro-grooves or micro-channels and a second etching to form the micro-wells.

31. A method according to claim 30, wherein the obtained silicon micro-mould is exposed to a CHF3 plasma treatment in order to minimize the adherence between the surface of the obtained silicon micro-mould and the membrane to be molded in said silicon micro-mould.

32. A method according to claim 22, wherein said manufacturing comprises obtaining a resist micro-mould by at least two successive UV exposures through a mask and without intermediate developing, the first exposure defining means for forming the micro-grooves and the second exposure, after spin-coating a second resist layer, defining means for forming the micro-wells.

33. A method according to claim 22, wherein said microfluidic structure is a biochip.

34. A microfluidic structure produced by the method according to claim 22.

35. The micofluidic structure according to claim 34 wherein the structure is a biochip.

36. A microfluidic structure comprising at least a membrane made of a polymer material and including at least micro-wells and micro-grooves or micro-channels interconnecting said micro-wells, said membrane constituting a three-dimensional micro-structure.

37. A microfluidic structure according to claim 36, further comprising at least a substrate, one surface of said substrate being applied on a surface of the membrane.

38. A microfluidic structure according to claim 36, wherein said structure is transparent.

39. A microfluidic structure according to claim 36, wherein said membrane is made of a polydimethylsiloxane.

40. A microfluidic structure according to claim 36, wherein the micro-wells of the membrane have dimensions varying from 30 μm to 100 μm, in that the membrane has a thickness of about 40 μm to 30 μm, in that the micro-channels have a rectangular section which sizes vary from 10 μm to 30 μm, and in that the number of micro-wells ranges from 100 to 10,000/cm².

41. A microfluidic structure according to claim 36, wherein all of the materials are biocompatible with biological substances and living cells.

42. A microfluidic structure according to claim 41, wherein the materials are rendered biocompatible with the biological substances and living cells to be treated by said microfluidic structure, by adding a biocompatible coating.
